(19) United States
(12) Patent Application Publication
(10) Pub. No.: US 2017/0264461 A1
(43) Pub. Date: Sep. 14, 2017

(54) COMMUNICATION APPARATUS AND COMMUNICATION METHOD

(71) Applicant: ALAXALA Networks Corporation, Kawasaki-shi (JP)

(72) Inventors: Toshimasa SASAMOTO, Kawasaki (JP); Kensuke INO, Kawasaki (JP)

(21) Appl. No.: 15/412,228

(22) Filed: Jan. 23, 2017

(30) Foreign Application Priority Data
Mar. 11, 2016 (JP) 2016-047754

(51) Int. Cl. H04L 12/46; H04L 12/741; H04L 29/06

(52) U.S. Cl. CPC H04L 12/4633; H04L 69/22; H04L 45/745

(57) ABSTRACT

A network apparatus which is one of two network apparatuses using a tunneling protocol and which accommodates a user, wherein the network apparatus includes a function for uniquely determining an identifier in a header of the tunneling protocol in accordance with a setting made by a network operation administrator, and encapsulating and transmitting a packet with the determined identifier, and the other network apparatuses connected to the DPI apparatus 10 includes a function of carrying out decapsulation processing, converting the identifier in the tunneling protocol header into an identifier associated with the output destination interface, attaching a conversion result to a decapsulated packet as an internal control tag, and transferring the conversion result to hardware carrying out packet transfer processing.

### INCORPORATION BY REFERENCE

The present application claims priority from Japanese application JP 2016-047754 filed on Mar. 11, 2016, the content of which is hereby incorporated by reference into this application.

### BACKGROUND OF THE INVENTION

The present invention relates to both a communication apparatus connected to a network for transferring a packet and a communication method using the same.

As network traffics become more versatile, there has been a higher demand for inspecting packets flowing on a network into details including payload information about the packets, and a deep packet inspection (DPI) apparatus has increasingly been introduced. A method for carrying out inspection is generally used, in which the DPI apparatus is a dedicated apparatus for the purpose of inspecting packets in an original format transmitted by a user, and a network apparatus for transmitting a packet to the DPI apparatus is connected to the DPI apparatus, and a port mirroring function is operated on the network apparatus, and the mirrored packets are transferred to the DPI apparatus to be inspected.

On the other hand, JP 2015-162693A describes a network configuration in which an application identification apparatus, which may increase the cost if it is installed on each circuit of a network, is shared on a large-scale network, and a control for an each application is configured to be transferred toward the application identification apparatus having been shared. In JP 2015-162693A, packets transferred from an application identification connection interface after multiple packet header identification control units extract a flow matching a steering policy are configured to be transmitted to the application identification apparatus via a relay apparatus specialized in relaying of packets transmitted to the application identification apparatus, so that sharing of the application identification apparatus is realized.

### SUMMARY OF THE INVENTION

The invention described in JP 2015-162693A illustrates an example of a network configuration in which the application identification apparatus is shared on a large-scale network.

On the other hand, it is an object of the present invention to provide a technique for a network configuration including a core network and an access network accommodating a user and in which the access network and the core network are connected via an edge router provided at an edge portion of the core network, wherein a packet from the user received by the edge router is transferred to a DPI apparatus connected to the core network.

In order to solve the problem, according to the present invention, for example, a communication apparatus performing processing for transmitting and receiving a packet to and from a network and perform processing on the packet, and performing transfer processing on the basis of a routing table, wherein when association information for associating a particular identifier of a tunneling protocol and an output destination interface is received in advance, association information for associating the particular identifier of the tunneling protocol and the output destination interface is set in an information storage unit and a routing table referred to when processing on the packet is performed, and in a case where an identifier of a tunneling protocol possessed by a packet obtained by decapsulating the received packet is the particular identifier, a tag for an internal control is attached to a head portion of the packet, and the association information for associating the particular identifier of the tunneling protocol and the output destination interface which is set in the routing table is read from the tag for the internal control, and the packet obtained by deleting the tag for the internal control is transferred to the output interface that has been set.

According to the present invention, a technique can be provided for a network configuration including a core network and an access network accommodating a user and in which the access network and the core network are connected via an edge router provided at an edge portion of the core network, wherein a packet from the user received by the edge router is transferred to a DPI apparatus connected to the core network. The problems and configuration other than the above would be clarified from the following explanation about the embodiments.

### BRIEF DESCRIPTION OF THE DRAWINGS

FIG. 1 is a figure illustrating a configuration example of a network according to an embodiment of the present invention;

FIG. 2 is a figure illustrating a configuration of an edge router and a gateway router according to an embodiment of the present invention;

FIG. 3 is a figure illustrating an interface for the gateway router and a DPI apparatus according to an embodiment of the present invention;

FIG. 4 is a figure illustrating an example of an access list for detecting a DPI inspection target packet with the edge router;

FIG. 5 is a figure illustrating an output policy example for a DPI inspection target packet flow with the edge router;

FIG. 6 is an input image of setting information for setting an output destination interface from the gateway router to the DPI apparatus by an operation administrator;

FIG. 7 is a figure illustrating an example of a format of a conversion information storage unit in the gateway router;

FIG. 8 is a figure illustrating a format example of an encapsulated packet received by the gateway router;

FIG. 9 is a figure illustrating a format example of a packet decapsulated by a packet operation unit of the gateway router;

FIG. 10 is a figure illustrating a format example of a packet transmitted by the gateway router gateway router after the decapsulation;

FIG. 11 is a figure illustrating a setting example of an output destination VRF of a core network in the edge router;

FIG. 12 is a figure illustrating a format example of a conversion information storage unit in the edge router;

FIG. 13 is a figure illustrating a format example of an encapsulated packet received by the edge router;

FIG. 14 is a figure illustrating a format example of a packet decapsulated by the packet operation unit of the edge router;

FIG. 15 is a figure illustrating an example of an access list in the edge router;

FIG. 16 is a figure illustrating an example of an output policy in the edge router;

FIG. 17 is a figure illustrating an output destination interface setting example to the DPI apparatus in the gateway router;

FIG. 18 is a figure illustrating a format example of a conversion information storage unit in the gateway router;

FIG. 19 is a figure illustrating a setting example of an output destination VRF to the access network in the edge router;

FIG. 20 is a figure illustrating a format example of the conversion information storage unit in the edge router; and

FIG. 21 is a figure illustrating a network configuration according to an embodiment of the present invention of the second embodiment.

### DETAILED DESCRIPTION OF THE INVENTION

Hereinafter, embodiments for carrying out the present invention will be explained with reference to drawings. However, the present invention is not limited to the present embodiment. Substantially the same portions as certain another portion will be denoted with the same reference numerals with each other, and explanation thereabout will not be repeated.

### First Embodiment

Embodiments of the present invention will be hereinafter explained with reference to drawings.

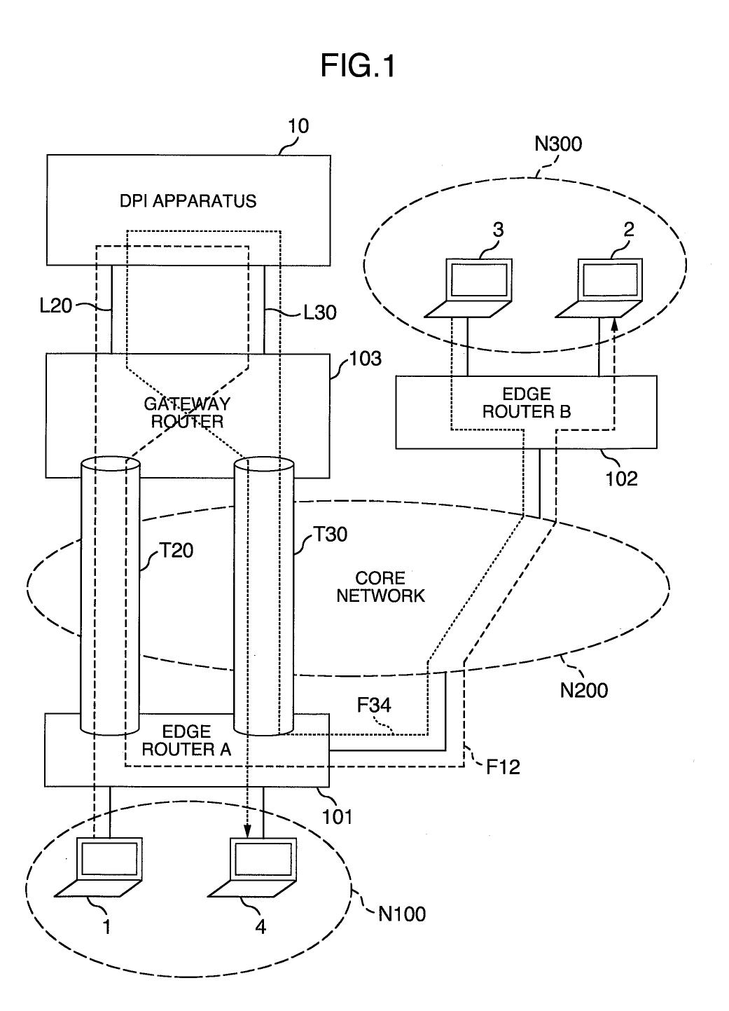

FIG. 1 is a figure illustrating a configuration example of a network according to an embodiment of the present invention. In the network according to the present embodiment, access networks N100, N300 respectively accommodating a user are connected with a core network N200 via an edge router A101 and an edge router B102 installed at the edge position of the core network. A DPI apparatus 10 is directly connected to a gateway router 103, and connected to the core network N200 via the gateway router 103.

In the present embodiment, the network configuration as illustrated in FIG. 1 allows a packet received by the edge router from a user or a packet transmitted to the user to be transferred to the DPI apparatus connected to the core network, and allows a packet that has already been inspected by the DPI apparatus to be transmitted via the core network to the destination of the packet transmitted by the user or transmitted to the user.

In this case, in the gateway router 103 as illustrated in FIG. 1, a packet obtained by decapsulating a packet transmitted from the edge router A101 by way of an uplink tunnel T20 and a downlink tunnel T30 is a packet in an original format transmitted by the user who belongs to the access network N100, or a packet transmitted to the edge router A101 via the core network N200, and these packets are considered to be attached with a VLAN tag given in the core network N200 or a virtual local area network (VLAN) according to the user who belongs to the access network N100. In addition, due to its characteristics, the DPI apparatus 10 is required to receive the original packet transmitted by the user, and is required to transmit the original packet to the destination of the packet transmitted by the user.

More specifically, this means that an interface other than the access port interface cannot be designated as the interface of the gateway router 103 connected to an uplink L20 and a downlink circuit L30. Therefore, in an environment accommodating users by using multiple VLANs in the access network N100, in a case where an existing layer 2 packet transfer method is used to perform packet transfer processing upon referring to a destination MAC address field and a VLAN tag and determining that the same VLAN as the reception packet is the output destination, there is a problem in that the gateway router 103 cannot transmit a packet to the DPI apparatus 10 without performing adding and replacing processing of a VLAN tag for the received packet, and therefore, the format transmitted by the user, i.e., the original packet, cannot be transferred to the DPI apparatus 10 (problem (1)).

Likewise, in a case where a packet is received by an interface using virtual routing and forwarding (VRF) when the packet is received from the access network N100 and the core network N200 by the edge router A101 as illustrated in FIG. 1, the edge router A101 receives a packet transmitted via the uplink tunnel T20 and the downlink tunnel T30 from the gateway router 103 by using the interface with which the edge router A101 is connected with the gateway router 103 via the tunnel. However, when the edge router A101 carries out routing processing by carrying out decapsulation processing on a received packet, the packet is received with an interface different from the interface for reception from the access network N100 and the core network N200, i.e., the interface of the uplink tunnel T20 and the downlink tunnel T30, so that information about the reception VRF is lost when the packet is received from the access network N100 and the core network N200. For this reason, there is a problem in that the edge router A101 cannot carry out routing processing for the DPI inspection target packet using the VRF (problem (2)).

Hereinafter, a configuration and an operation according to the present embodiment for solving the above problems (1) and (2) will be explained, in which, in the network configuration as illustrated in FIG. 1, a packet from a user received by the edge router or a packet transmitted to a user is transferred to the DPI apparatus connected to the core network, and a packet that has been inspected by the DPI apparatus is transmitted to the destination of the packet transmitted by the user or to the user via the core network.

The edge router A101 accommodates a user 1 and a user 4 into the access network N100, and the edge router B102 accommodates a user 2 and a user 3 into the access network N300.

The gateway router 103 directly connected to the DPI apparatus 10 via the uplink L20 and the downlink circuit L30. The DPI apparatus 10 is a dedicated apparatus for the purpose of inspecting a packet in an original format transmitted by a user. Therefore, when a packet transmitted from the core network N200 to the user accommodated in the edge router A101 and a packet transmitted by a user accommodated in the edge router A101 are transmitted to and received from the DPI apparatus via the gateway router 103, the interface of the gateway router 103 connected to the uplink L20 and the downlink circuit L30 needs to be an interface that does not add or replace the VLAN tag.

The uplink L20 indicates a circuit in which a packet transferred in a direction from the access network N100 to the core network N200 is received by the DPI apparatus 10 or a packet transferred in a direction from the core network N200 to the access network N100 is transmitted by the DPI apparatus 10, and the downlink circuit L30 indicates a circuit in which a circuit in which a packet transferred in a direction from the core network N200 to the access network N100 is received by the DPI apparatus 10 or a packet transferred in a direction from the access network N100 to the core network N200 is transmitted by the DPI apparatus 10.

The gateway router 103 uses a tunneling protocol to connect to the edge router A101 via the uplink tunnel T20 and the downlink tunnel T30. In the present embodiment, the tunneling protocol used for connection is considered to use VXLAN (Virtual eXtensible Local Area Network) protocol for convince, but this is merely an example. The used tunneling protocol is not particularly limited, and other tunneling protocols may be used. The detailed operation of the VXLAN protocol to be used will not be explained.

In addition, the uplink tunnel T20 and the downlink tunnel T30 can be multiplexed logically, and multiple tunnels may be configured to be accommodated within a single circuit. The uplink tunnel T20 indicates a tunnel for allowing a packet transmitted in the direction from the access network N100 to the core network N200 to pass through, and the downlink tunnel T30 indicates a tunnel for allowing a packet transmitted in the direction from the core network N200 to the access network N100 to pass through.

In FIG. 1, F12 denotes a packet flow when a packet is transmitted from the user 1 accommodated in the access network N100 to the user 2 accommodated in the access network N300, and F34 denotes a packet flow when a packet is transmitted from the user 3 accommodated in the access network N300 to the user 4 accommodated in the access network N100.

Packets which are to be inspected by the DPI apparatus 10 are packets which are flowing in the packet flow F12 and which are received by the edge router A101 from the access network N100 and packets which are flowing in the packet flow F34 and which are transmitted by the edge router 101 to the user 4.

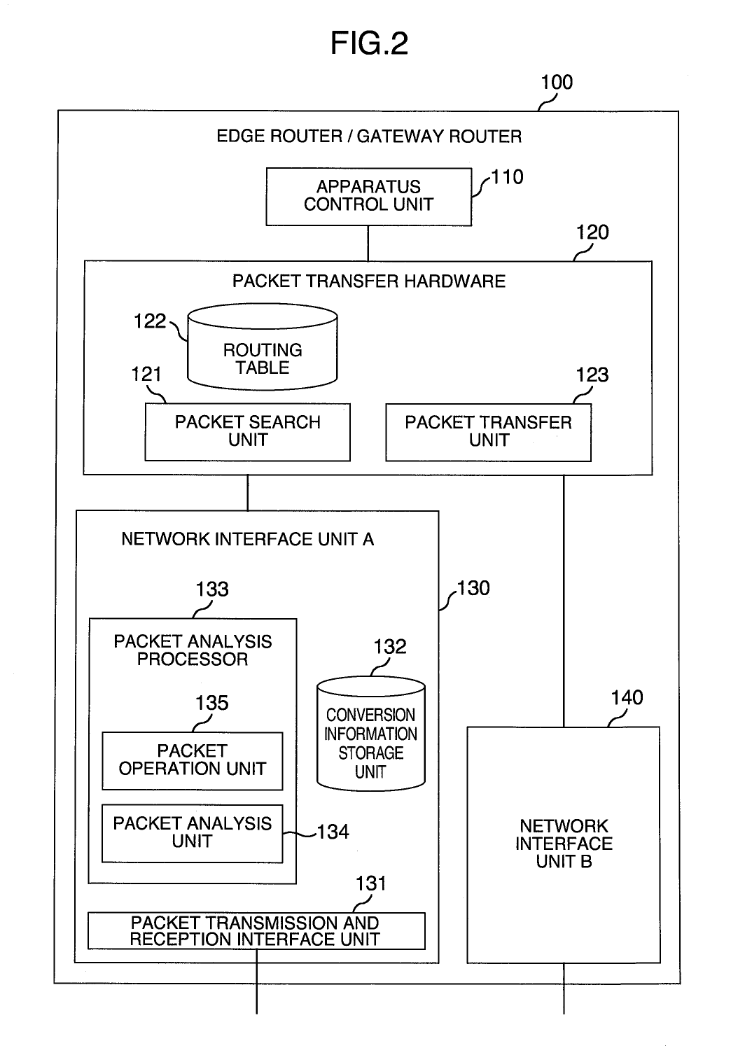

FIG. 2 is a figure illustrating a configuration of an edge router and a gateway router according to an embodiment of the present invention.

FIG. 2 illustrates an internal structure of the edge router A101, the edge router B102, and the gateway router 103, and unless otherwise specified, the edge router A101, the edge router B102, and the gateway router 103 will be collectively referred to as an edge router/gateway router 100.

The edge router/gateway router 100 includes a user interface (not shown) with which a network operation administrator changes apparatus settings and obtains operation information and the like and an apparatus control unit 110 having a function of performing various kinds of network protocol processing, and also includes a packet transfer hardware 120 connected to the apparatus control unit 110 via a bus, and includes a network interface unit A 130 and a network interface unit B 140 connected to the packet transfer hardware 120 via a bus.

In the edge router A101, the network interface unit A 130 and the network interface unit B 140 accommodate a circuit accommodating the user 1 and a circuit used for the uplink tunnel T20 and the downlink tunnel T30, and in the gateway router 103, the network interface unit A 130 and the network interface unit B 140 accommodate a circuit used for the uplink tunnel T20 and the downlink tunnel T30.

In the edge router A101, the network interface unit A 130 and the network interface unit B 140 accommodate a circuit connected to the core network N200 and a circuit accommodating the user 4, and in the gateway router 103, the network interface unit A 130 and the network interface unit B 140 accommodate the uplink L20 and the downlink circuit L30.

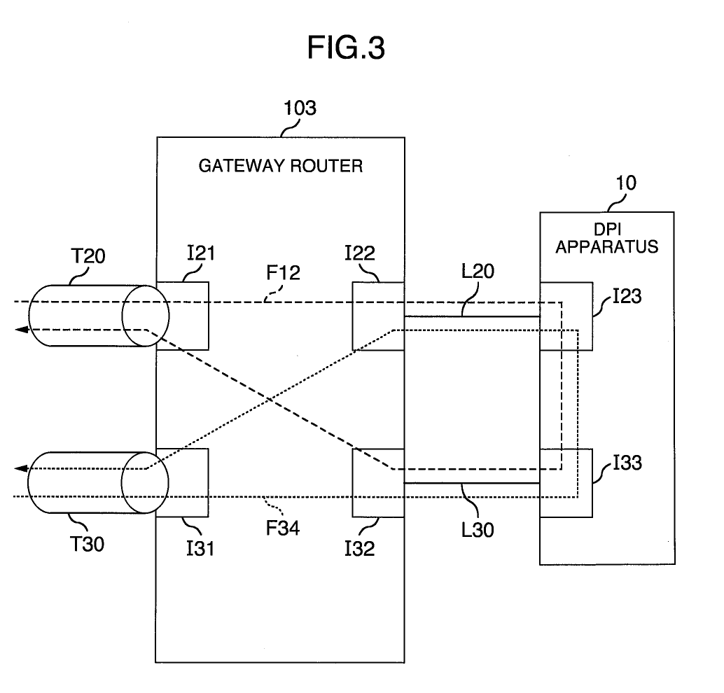

FIG. 3 is an explanatory diagram illustrating interfaces connected to circuits in the gateway router and the DPI apparatus.

In the gateway router 103, the uplink tunnel T20 is connected to an interface 121, and the uplink L20 is connected to an interface 122. The downlink tunnel T30 is connected to an interface 131, and the downlink circuit L30 is connected to an interface 132. In the DPI apparatus 10, the uplink L20 is connected to an interface 123, and the downlink circuit L30 is connected to an interface 133.

Back to FIG. 2, for convenience, in the description of the present embodiment and FIG. 2, there is a single apparatus control unit 110 and a single piece of packet transfer hardware connected to the apparatus control unit 110, but when a cross bus switch and the like is used, multiple pieces of packet transfer hardware may be connected to multiple apparatus control units 110 or multiple apparatus control units including the apparatus control unit 110.

Likewise, the number of network interface units connected to the packet transfer hardware is not limited.

The packet transfer hardware 120 includes a packet search unit 121 for searching an output destination of a packet transmitted and received, a routing table 122 which is to be searched by the packet search unit 121, and a packet transfer unit 123 for transferring a packet to a transfer destination determined by the search result of the packet search unit 121.

The network interface unit A 130 includes a packet transmission and reception interface unit 131 which is an interface for transmitting and receiving a packet, a conversion information storage unit 132 storing information set by the network operation administrator, and a packet analysis processor 133 which is a processor for analyzing a packet transmitted and received. The packet analysis processor 133 can also use an application specific integration circuit (ASIC) 3 and a field programmable gate array (FPGA) as an alternative to a processor.

The packet analysis processor 133 includes a packet analysis unit 134 for analyzing header information about a packet transmitted and received and a packet operation unit 135 processing a header of a packet analyzed by the packet analysis unit 134 in accordance with a protocol and information that is set by the network operation administrator.

Hereinafter, a detailed operation will be explained while focusing on the flow indicated by F12 of FIG. 1, in which, in the present embodiment, the apparatus as illustrated in FIG. 1 receives a packet transmitted from the user 1 to the user 2.

First, a packet transmitted from the user 1 of FIG. 1 is received by the edge router A101 accommodating the user.

The packet analysis unit 134 of the edge router A101 determines that the received packet is a DPI inspection target packet, i.e., a packet which is to be transferred to the DPI apparatus. The details of the identification method of the inspection target packet will not be explained in the present embodiment, but a method for identifying an inspection target packet by designating a packet condition based on an access list may be cited as an example of an identification method.

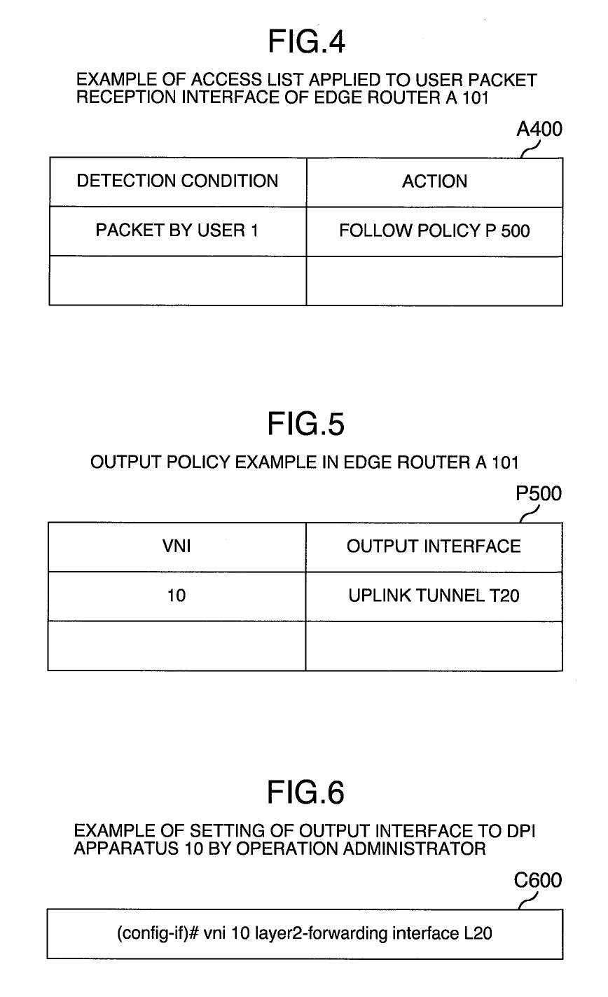

FIG. 4 is a figure illustrating an example of an access list used to identify the DPI inspection target packet in the edge router.

In the present embodiment, subsequent processing of the packet flow will be explained, where an access list A400 as illustrated in FIG. 4 is applied to the interface receiving packets from the user 1, and the packet analysis unit 134 identifies the inspection target packet.

FIG. 5 is a figure illustrating an example of an output policy for the DPI inspection target packet in the edge router.

The packet operation unit 135 is configured to carry out an encapsulation for a packet having been matched with an access list A400 by the VXLAN protocol in accordance with an output policy P500 that is set by the network operation administrator as illustrated in FIG. 5. In the encapsulation processing, in the present embodiment, for example, encapsulation is carried out while a VXLAN network identifier (VNI) value in VXLAN is set to 10.

The packet analysis processor 133 transfers the packet encapsulated in this processing to the packet transfer hardware 120.

The packet transfer hardware 120 performs packet transfer processing in accordance with the routing table 122, and transfers a packet from the network interface unit B 140 to the uplink tunnel T20.

A packet that is output to the uplink tunnel T20 passes through the core network N200 and reaches the gateway router 103.

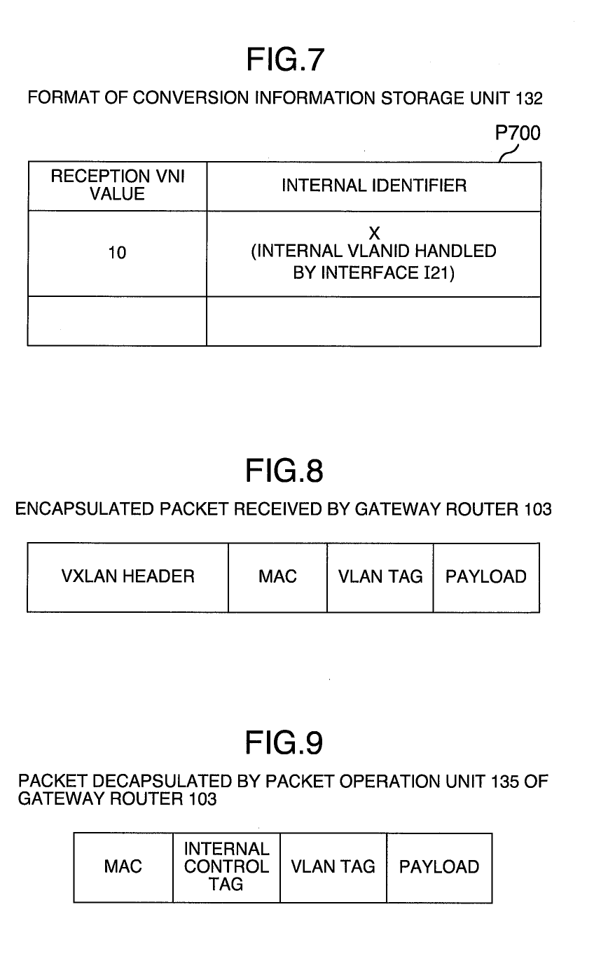

FIGS. 6 and 7 will be hereinafter explained.

C600 as illustrated in FIG. 6 is an input image of setting information with which the network operation administrator of the gateway router 103 sets an output destination interface to the DPI apparatus. In this setting C600, the VNI value in the reception packet and the output destination interface 122 corresponding to the uplink L20 are associated with each other. It should be noted that the setting example C600 is an example according to the present embodiment, and even if a setting format is a format other than this format, a setting format associating the VNI value of the reception packet and the output destination interface may be used.

When the setting as illustrated in FIG. 6 is carried out, the apparatus control unit 110 of the gateway router 103 transmits setting information to the packet analysis processor 133 via an internal bus.

FIG. 7 is a figure illustrating an example of a format of a conversion information storage unit in the gateway router.

The packet analysis processor 133 stores, for example, setting information to the conversion information storage unit 132 in the format of P700 as illustrated in FIG. 7. P700 is constituted by a reception VNI value and an internal identifier. In the present embodiment, the internal identifier is considered to use a value X corresponding to the interface 122. It should be noted that the value X is an internal VLANID corresponding only to the interface 122.

The apparatus control unit 110 of the gateway router 103 also transmits, to the routing table 122 of the packet transfer hardware 120, setting information indicating a correspondence between the VNI value in the reception packet that is set by C600 and the output destination interface 122 corresponding to the uplink L20, and carries out the setting in the routing table 122 as illustrated in FIG. 6.

The explanation about the packet flow F12 will be hereinafter continued.

FIG. 8 is a figure illustrating a format of an encapsulated packet received by the gateway router.

A packet having reached the gateway router 103 via the uplink tunnel T20 is received by the packet transmission and reception interface unit 131 in a format as illustrated in FIG. 8. As a result of the packet analysis, the packet analysis unit 134 receives the packet in the VXLAN format, so that the packet analysis unit 134 determines that the received packet is the decapsulation target.

The packet analysis processor 133 that determined that the received packet is the decapsulation target carries out the decapsulation processing of the packet received by the packet operation unit 135. In this decapsulation processing, the packet operation unit 135 refers to the conversion information storage unit 132. At this occasion, in a case where the reception VNI value is 10, conversion processing from the reception VNI value to X which is the internal VLANID of the output destination interface is carried out, and further, an internal control tag having X as VLANID is generated. The internal control tag does not need to be a VLAN tag in a format defined by IEEE802.1Q, and may be any format with which the packet transfer hardware 120 can recognize that the input VLANID is X. The packet operation unit 135 attaches the generated internal control tag between a MAC address field and a VLAN tag field of the packet on which the decapsulation processing is carried out.

FIG. 9 is a figure illustrating a format example of a packet decapsulated by the packet operation unit of the gateway router.

For example, the internal control tag generated by the packet operation unit 135 attaches between the MAC address field and the VLAN tag field of the packet on which the decapsulation processing is carried out, so that the received packet can have a packet format as illustrated in FIG. 9.

The packet as illustrated in FIG. 9 is transferred by the network interface unit A 130 to the packet search unit 121 provided in the packet transfer hardware 120 via the internal bus.

The packet search unit 121 refers to a destination MAC address field of the received packet, and determines that the reception packet is a packet of a layer 2 transfer target. This is because the decapsulated packet is a packet which the user 1 transmits to the edge router A101 in the access network N100, and accordingly, the destination MAC address is determined to be the edge router A101, i.e., not addressed to the gateway router 103.

In order to carry out the layer 2 transfer, the packet search unit 121 carries out search of VLANID of the interface with which the packet is received and the output destination interface to which the VLANID belongs while the routing table 122 is used as the search target. In this processing, the VLANID of the interface with which the packet is received is recognized as being X which is the VLANID of the VLAN tag of the first stage inserted in the packet operation processing of the network interface unit A 130. More specifically, the packet search unit 121 carries out the search of the interface which belongs to VLANID=X. The routing table 122 reflects setting information indicating that X explained in FIG. 6 is the internal VLANID corresponding to only the interface 122, and returns the interface 122 as a search result. On the basis of this search result, the packet search unit 121 transfers the packet to the packet transfer unit 123.

The packet transfer unit 123 determines that the output destination interface of the packet is the uplink L20. At this occasion, the interface 122 is an access port interface, and therefore, a VLAN tag attached to the head of the packet, i.e., the internal control tag, is deleted, and thereafter, via the internal bus, the packet is transferred to the network interface unit B 140 accommodating the uplink L20.

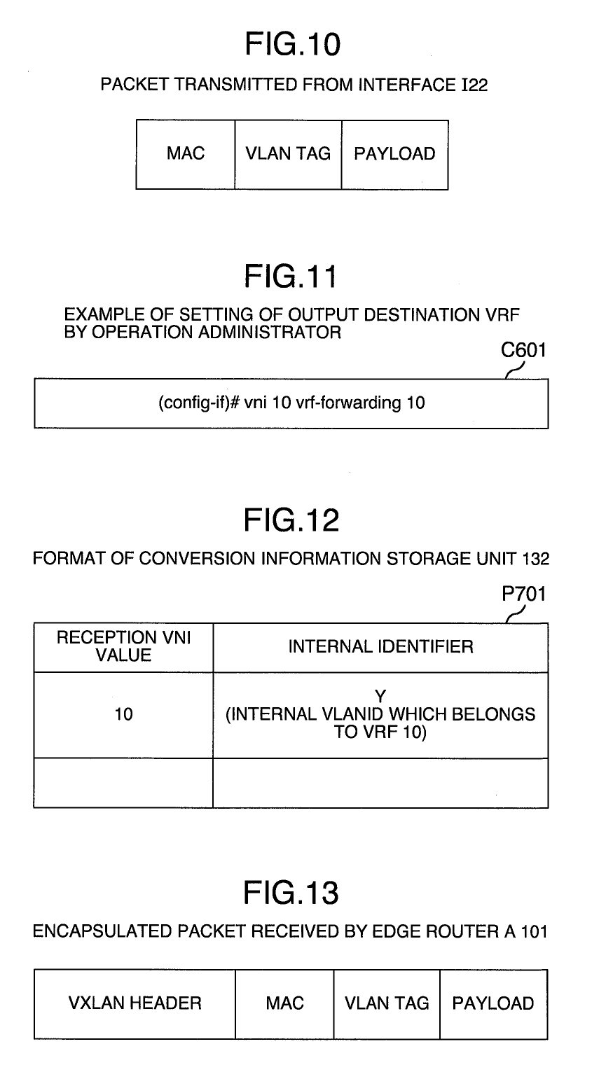

FIG. 10 is a figure illustrating a format of a packet transmitted from the interface 122 of the gateway router.

The network interface unit B 140 transmits a packet from the uplink L20. At this occasion, the format of the packet is a format as illustrated in FIG. 10, and is the same format as the original packet transmitted by the user 1.

According to the above procedure, the packet transmitted by the user 1 can reach the DPI apparatus 10 while the original format is maintained, so that the problem (1) is solved.

The packet having reached the DPI apparatus 10 is inspected by the function provided in the DPI apparatus 10, and the packet is transmitted from the downlink circuit L30 while the original format is maintained, and the packet is received by the interface 132 of the gateway router 103, and thereafter, the packet is encapsulated again with VXLAN. At this occasion, the VNI value in the VXLAN header is encapsulated by using “10”, which is the same as the value before the inspection with the DPI apparatus 10. The encapsulated packet is transmitted from the interface 121 by way of the uplink tunnel T20 to the edge router A101 again.

Subsequently, a configuration and an operation for performing routing processing on the DPI inspection target packet by using VRF in the edge router will be explained.

FIG. 11 is an input image of setting information with which a network operation administrator sets the output destination VRF of the core network or the access network in the edge router.

C601 as illustrated in FIG. 11 is a setting example which the network operation administrator of the edge router A101 sets VRF transfer to the core network N200. In this setting C601, the VNI value in the reception packet and the output destination VRF number for output to the core network N200 are associated with each other. It should be noted that the setting example C601 is an example according to the present embodiment, and even if a setting format is a format other than this format, a setting format associating the VNI value of the reception packet and the output destination interface may be used.

When the setting as illustrated in FIG. 11 is carried out, the apparatus control unit 110 of the edge router A101 transmits setting information via the internal bus to the packet analysis processor 133.

FIG. 12 is a figure illustrating a format example of a conversion information storage unit in the edge router. The packet analysis processor 133 stores the setting information to the conversion information storage unit 132 in a format of P701 as illustrated in FIG. 12. P701 is constituted by a combination of a reception VNI value and an internal identifier. In the present embodiment, the internal identifier is considered to use the value Y corresponding to the VRF “10”. It should be noted that Y denotes an internal VLANID which belongs to the VRF “10”.

The apparatus control unit 110 of the edge router A101 also transmits, to the routing table 122 of the packet transfer hardware 120, setting information indicating association between the output destination VRF number and the VNI value in the reception packet that is set in C601, and carries out the setting on the routing table 122 as illustrated in FIG. 11.

The explanation about the packet flow F12 will be hereinafter continued.

FIG. 13 is a figure illustrating a format of an encapsulated packet received by the edge router.

The packet reaching the edge router A101 via the uplink tunnel T20 is received by the packet transmission and reception interface unit 131 in a format as illustrated in FIG. 13.

As a result of packet analysis, the packet analysis unit 134 receives the packet of the VXLAN format, so that the packet analysis unit 134 determines that the received packet is the decapsulation target.

The packet analysis processor 133 having determined that the received packet is the decapsulation target causes the packet operation unit 135 to carry out the decapsulation processing of the reception packet. In this decapsulation processing, the packet operation unit 135 refers to the conversion information storage unit 132. At this occasion, conversion processing from the reception VNI value to Y which is the internal VLAN number which belongs to the output VRF number is carried out, and further, an internal control tag having Y as VLANID is generated. The internal control tag does not need to be a VLAN tag in a format defined by IEEE802.1Q, and may be any format with which the packet transfer hardware 120 can recognize that the input VLAN is Y. The packet operation unit 135 attaches the generated internal control tag between a MAC address field and a VLAN tag field of the packet on which the decapsulation processing is carried out.

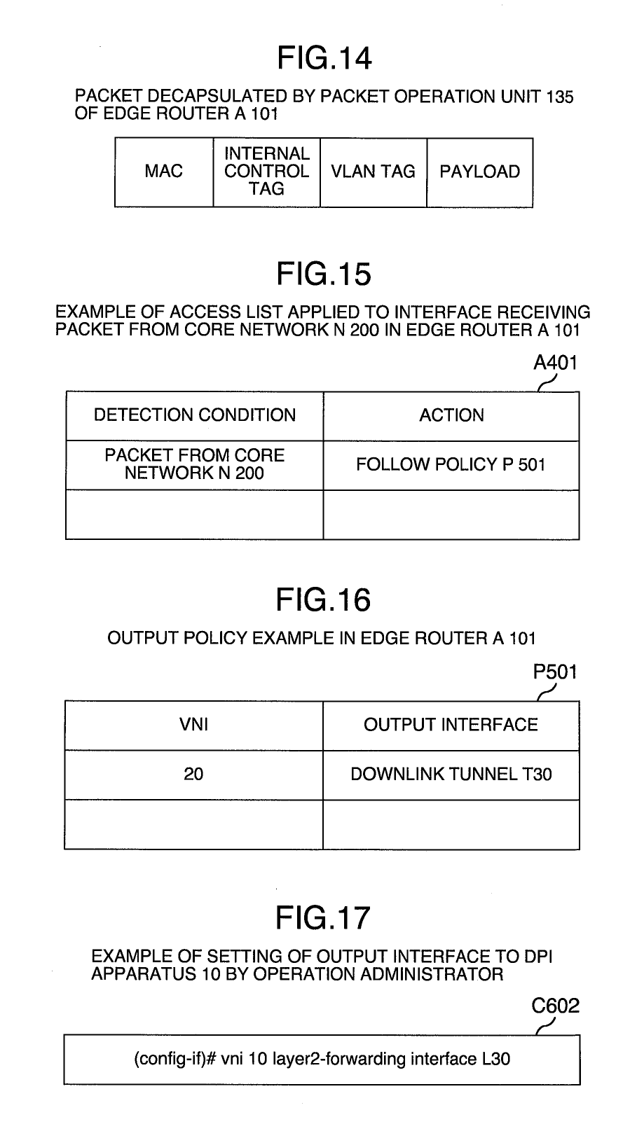

FIG. 14 is a figure illustrating a format example of a packet decapsulated by the packet operation unit of the edge router.

The internal control tag generated by the packet operation unit 135 attaches between the MAC address field and the VLAN tag field of the packet on which the decapsulation processing is carried out, so that the received packet can have a packet format as illustrated in FIG. 14.

In addition to the processing for attaching the internal control tag, the packet operation unit 135 changes the destination MAC address field of the packet to the MAC address of the edge router A101.

The packet analysis processor 133 transfers a packet received by the packet search unit 121 provided in the packet transfer hardware 120 via the internal bus.

The packet search unit 121 refers to the destination MAC address field of the received packet, and determines that the reception packet is a packet of the layer 3 transfer target. This is because, with the processing of the packet operation unit 135, the destination MAC address is set to the edge router A101.

In order to carry out the layer 3 transfer, the packet search unit 121 carries out search, with the routing table 122 being the search target, a layer 3 path and an output destination interface from VLANID of the interface with which the packet is received and the destination IP address. In this processing, the VLANID of the interface with which the packet is received is recognized as being Y which is the VLANID of the first stage inserted in the packet operation processing of the packet operation unit 135. More specifically, the packet search unit 121 carries out the search of the output destination interface with the path of the VRF number 10 which belongs to VLANID=Y is adopted as the search target. As described above, Y is the internal VLANID corresponding to VRF “10”, and therefore, the output destination interface for the VRF number “10” is returned as the search result. On the basis of this search result, the packet search unit 121 transfers a packet to the packet transfer unit 123.

The packet transfer unit 123 recognizes that the output destination interface of a packet is the output destination interface to the core network N200. At this occasion, the output destination interface to the core network N200 is an access port interface or a trunk port interface. In a case where the output destination interface to the core network N200 is an access port interface, a VLAN tag at the head of the packet, i.e., the internal control tag, is deleted, and thereafter, the packet is transferred to the network interface unit B 140 accommodating the circuit connected to the core network N200 via the internal bus. In a case where the output destination interface to the core network N200 is a trunk port interface, a VLAN tag at the head of the packet, i.e., the internal control tag, is deleted, and thereafter, a VLAN tag handled by the output destination interface is attached, and the packet is transferred to the network interface unit B 140 accommodating the circuit connected to the core network N200 via the internal bus.

The network interface unit B 140 transmits a packet from the circuit connected to the core network N200.

According to the above procedure, when the packet transmitted from the user 1 is received again by the edge router A101 by way of the DPI apparatus 10, the packet is transferred to the core network N200 with the VRF “10”, so that the problem (2) is solved.

From the view point of the edge router A101, the packet flow F12 is an uplink packet flow for transferring packets in a direction from the access network N100 to the core network N200, whereas the packet flow F34 is a downlink packet flow for transferring packets in a direction from the core network N200 to the access network N100. More specifically, the packet flow F34 is not different from the packet flow F12 except that the downlink tunnel T30 is used and that the packet transfer direction on the downlink circuit L30 is opposite to the plink circuit L20, and a method similar to the packet flow F12 can be applied to the packet flow F34.

The processing for the packet flow F34 is similar to the processing for the packet flow F12, and therefore, only the drawings will be hereinafter explained, and the detailed explanation thereabout will be omitted.

FIG. 15 is a figure illustrating an example of an access list used for identification of the DPI inspection target packet in the edge router.

In the present embodiment, the access list A401 as illustrated in FIG. 15 is applied to the interface for receiving packets from the user 3, i.e., the interface for being connected to the core network N200, and the packet analysis unit 134 identifies the inspection target packet.

FIG. 16 is a figure illustrating an example of an output policy for the DPI inspection target packet in the edge router. The packet operation unit 135 carries out encapsulation of a packet matching an access list A401 by setting “20” in the VNI value in the VXLAN header in accordance with an output policy P501 that is set by the network operation administrator as illustrated in FIG. 16.

C602 as illustrated in FIG. 17 is an input image example of setting information with which the network operation administrator of the gateway router 103 sets the output destination interface to the DPI apparatus. In this setting C602, the VNI value in the reception packet and the output destination interface 132 corresponding to the downlink circuit L30 are associated with each other. It should be noted that the setting example C602 is an example according to the present embodiment, and even if a setting format is a format other than this format, a setting format associating the VNI value of the reception packet and the output destination may be used.

When the setting as illustrated in FIG. 17 is carried out, the apparatus control unit 110 of the gateway router 103 transmits setting information via the internal bus to the packet analysis processor 133.

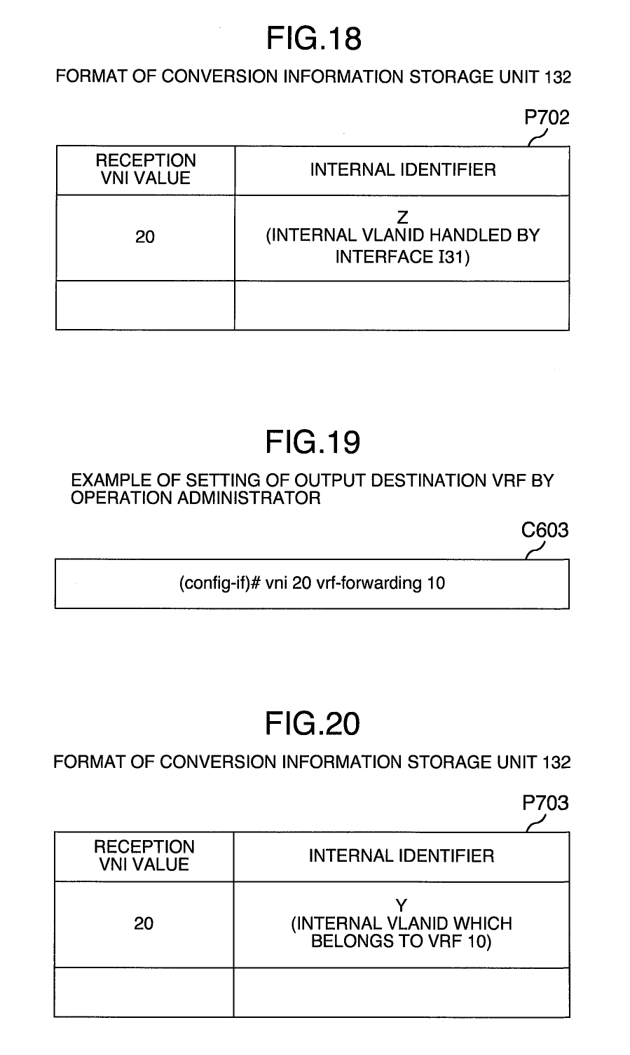

FIG. 18 is a figure illustrating an example of a format of the conversion information storage unit in the gateway router.

The packet analysis processor 133 stores the setting information to the conversion information storage unit 132 in a format of P702 as illustrated in FIG. 18, for example. P702 is constituted by a combination of a reception VNI value and an internal identifier. In the present embodiment, the internal identifier is considered to use a value Z corresponding to the interface 132. The “Z” is an internal VLANID corresponding to only the interface 132.

C603 as illustrated in FIG. 19 is a VRF transfer setting example to the access network N100 by the network operation administrator of the edge router A101. In this setting C603, the VNI value in the reception packet and the output destination VRF number during output to the access network N100 are associated with each other. It should be noted that the setting example C603 is an example according to the present embodiment, and even if a setting format is a format other than this format, a setting format associating the VNI value of the reception packet and the output destination VRF number may be used.

When the setting as illustrated in FIG. 19 is carried out, the apparatus control unit 110 of the edge router A101 transmits setting information via the internal bus to the packet analysis processor 133.

FIG. 20 is a figure illustrating a format example of a conversion information storage unit in the edge router. The packet analysis processor 133 stores the setting information to the conversion information storage unit 132 in a format of P703 as illustrated in FIG. 20. P703 is constituted by a combination of a reception VNI value and an internal identifier. In the present embodiment, the internal identifier is considered to use a value Y corresponding to the VRF “10”. The “Y” is an internal VLANID which belongs to the VRF “10”.

The apparatus control unit 110 of the edge router A101 also transmits, to the routing table 122 of the packet transfer hardware 120, setting information indicating association between the output destination VRF number and the VNI value in the reception packet that is set in C603, and carries out the setting on the routing table 122 as illustrated in FIG. 19.

According to the present embodiment, without providing any dedicated apparatus in the network, a packet from the user received by the edge router is transferred to the shared DPI apparatus connected to the core network by using the edge router and the gateway router, and a packet that has already been inspected by the common DPI apparatus can be transmitted via the core network to the destination of the packet transmitted by the user or to the user.

### Second Embodiment

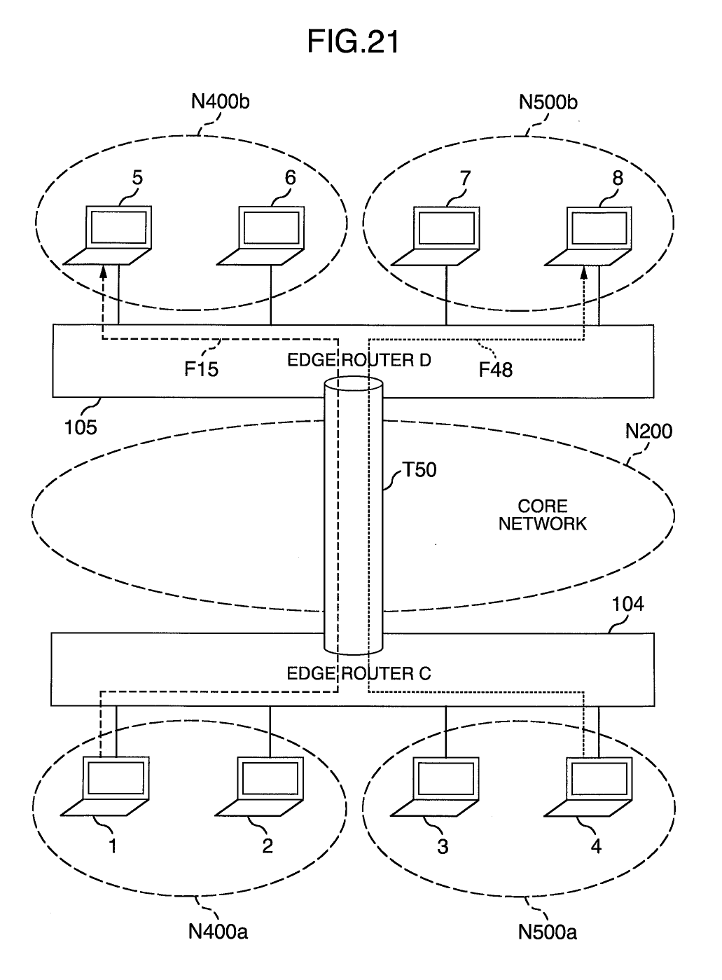

The second embodiment of the present invention will be hereinafter explained with reference to drawings. FIG. 21 is a figure illustrating a second embodiment of the present invention. An edge router C104 accommodates a user 1 and a user 2 into a network N400a, and the edge router C104 accommodates a user 3 and a user 4 into a network N500a.

An edge router D105 accommodates a user 5 and a user 6 into a network N400b, and the edge router D105 accommodates a user 7 and a user 8 into a network N500b.

The internal configuration of the edge router C104 and the edge router D105 is configured as illustrated in FIG. 2 as illustrated in the embodiment.

The edge router C104 and the edge router D105 are connected via a tunnel T50 by using a tunneling protocol via a core network N200.

A packet flow F15 indicates a flow used when a packet is transmitted from the user 1 to the user 5, a packet flow F48 indicates a flow used when a packet is transmitted from the user 4 to the user 8.

In a case where a packet addressed to the network N400b is received from the network N400a, the edge router C104 uses the layer 2 tunneling protocol to encapsulate and output a packet when the packet is output to the tunnel T50. In a case where a packet addressed to the network N500b is received from the network N500a, the edge router C104 uses the layer 3 tunneling protocol to encapsulate and output a packet when the packet is output to the tunnel T50.

In the network system as illustrated in FIG. 21, the present invention as illustrated in the embodiment is applied to the edge router D105, so that when the edge router D105 receives a packet encapsulated, the edge router D105 performs conversion processing from the tunneling protocol identifier in the encapsulated packet to the output destination interface, so that the output destination interface can be forcibly designated. The detailed processing is already described in the embodiment, and is therefore omitted.

When the embodiment is applied, the edge router D105 can perform conversion processing from the tunneling protocol identifier in the encapsulated packet to the output destination interface, perform the layer 2 transfer processing forcibly designating the output destination interface, perform conversion processing from the tunneling protocol identifier to the output VRF, and can perform the layer 3 transfer processing in accordance with the VRF path.

It should be further understood by those skilled in the art that although the foregoing description has been made on embodiments of the invention, the invention is not limited thereto and various changes and modifications may be made without departing from the spirit of the invention and the scope of the appended claims.

1. A communication apparatus comprising:
a plurality of network interface units which are communication apparatuses for transmitting and receiving a packet on a network and which perform processing for transmitting and receiving the packet to and from the network and perform processing on the packet;
one or more packet transfer units 123 which perform, on the basis of a routing table 122, transfer processing on a packet that is output from the network interface unit; and
a control unit controlling each unit of the communication apparatus,
wherein when the control unit receives association information for associating a particular identifier of a tunneling protocol and an output destination interface in advance, the control unit sets the association information for associating the particular identifier of the tunneling protocol and the output destination interface in an information storage unit of the network interface unit and a routing table 122 of the packet transfer unit 123,
in a case where an identifier of a tunneling protocol possessed by a packet obtained by decapsulating the received packet is the particular identifier, the network interface unit attaches a tag for an internal control to a head portion of the packet and outputs the packet to the packet transfer unit 123, and
the packet transfer unit 123 reads, from the tag for the internal control, the association information for associating the particular identifier of the tunneling protocol and the output destination interface which is set in the routing table 122, and transfers the packet obtained by deleting the tag for the internal control to the output interface that has been set.

2. The communication apparatus according to claim 1, wherein the particular identifier is associated with the output interface of the communication apparatus on the basis of a policy set in advance in a packet satisfying a detection condition that is set in advance in the communication apparatus.

3. The communication apparatus according to claim 1, wherein the tunneling protocol is a VXLAN protocol, and the particular identifier is a VNI.

4. The communication apparatus according to claim 3, wherein the information about the output destination interface associated with the particular identifier is interface information associated with VRF.

5. A communication method for performing processing for transmitting and receiving a packet to and from a network and performing processing on the packet, and performing transfer processing on the basis of a routing table 122,
wherein when association information for associating a particular identifier of a tunneling protocol and an output destination interface is input, association information for associating the particular identifier of the tunneling protocol and the output destination interface is set in an information storage unit and the routing table 122 referred to when processing on the packet is performed,
in a case where an identifier of a tunneling protocol possessed by a packet obtained by decapsulating the received packet is the particular identifier, a tag for an internal control is attached to a head portion of the packet, and the association information for associating the particular identifier of the tunneling protocol and the output destination interface which is set in the routing table 122 is read from the tag for the internal control, and the packet obtained by deleting the tag for the internal control is transferred to the output interface that has been set.

6. The communication method according to claim 5, wherein the particular identifier is associated with the output interface of the communication apparatus on the basis of a policy set in advance in a packet satisfying a detection condition that is set in advance.

7. The communication method according to claim 5, wherein the tunneling protocol is a VXLAN protocol, and the particular identifier is a VNI.

8. The communication method according to claim 7, wherein the information about the output destination interface associated with the particular identifier is interface information associated with VRF.
